(19) United States
(12) Patent Application Publication
(10) Pub. No.: US 2009/0216604 A1
(43) Pub. Date: Aug. 27, 2009

(54) METHOD AND SYSTEM FOR PROCESS SOLUTION DEVELOPMENT AND PROCESS SOLUTION IMPLEMENTATION

(76) Inventor: Hillel Glazer, Owings Mills, MD (US)

Correspondence Address: Saul Ewing LLP (Baltimore);Attn: Patent Docket Clerk, Lockwood Place, 500 East Pratt Street, Suite 900, Baltimore, MD, 21202, US

(21) Appl. No.: 12/394,015

(22) Filed: Feb. 26, 2009

Related U.S. Application Data
(60) Provisional application No. 61/031,800, filed on Feb. 27, 2008.

(51) Int. Cl. G06Q 10/00

(52) U.S. Cl. 705/9; 705/7; 705/8

(57) ABSTRACT

A method for process improvement implementation by identifying a business life cycle and then characterizing at least one business focused document; identifying a product life cycle and a process improvement activity and characterizing at least one project focused document with respect to these and after inputting predetermined organizational standards, synthesizing and implementing an organizational-specific process improvement solution.

### FIELD

The field of the invention relates to process solution methods and, particularly to, process solution implementation.

### BACKGROUND

Implementation of process improvement systems and methodologies often involve the collection of practices that describe characteristics of effective processes. Historically effective solutions are assigned to identified process problems or issues post identification of certain flawed business processes. Methods such as CAPABILITY MATURITY MODEL® INTEGRATION (“CMMI”) is a process improvement approach that provides organizations with the essential elements of effective processes. It can be used to guide process improvement across a project, a division or an entire organization. CMMI and other process improvement methods help integrate traditionally separate organizational functions, set process improvement goals and priorities, and provide guidance. They can forcibly transfigure process needs of the business into pre-determined historical process solutions which fail to account for the individual needs of the businesses. The unique practices that define the business process are not accounted for. Currently, process improvement methods do not transform to meet the needs of the particular business. Other process solution implementations known in the art perform additional, predictable, and pattern-based solutions that generally lead towards failure at worst, and short-term gains at best because the specific needs and unique requirements of a business are not accounted for.

Process solution systems often may possess the following problems which have yet to be solved: misuse of the models as a process; misuse of a model as a process standard; a lack of any notion or assessment of a “process architecture”; a lack of identifying and/or distinguishing project life cycles from product life cycles (i.e., the organization's “reality”); lack of identifying and/or distinguishing process activities as a function of project and product life cycles.

Approaches for process solutions can focus on processes in a vacuum. That is, they look at processes in terms of “current state” and “desired state” but fail to look at the context within which the processes are being implemented. In other words, they look at the processes in an idealized “perfect” state while ignoring the realities of how the processes are actually used in the context of the actual business; thus, failing to implement processes and process improvement in a context that actually improves the organization's operations. Instead, process activities are implemented that can be distant and disconnected from actual work. As such, the above said process solutions are difficult to distribute and sustain.

A widely adopted approach to process improvement is process-centric and lacks anything relating to process architecture. Currently, the approach to process solutions generally involves the methodology of finding process gaps and closing the gaps between them at the process level.

The current approach to process solutions fails to identify and define what the actual project and product life cycles are and does not see where the process activities are happening in order to apply the model activities into those existing activities. In the case of CMMI, which is a model and not a standard, a typical approach often seen in existing practices is it's comparison to a particular instance of the model—which then acts as a de-facto benchmark standard. After this comparison, existing practices and processes are modified or supplemented by activities to specifically enact the benchmark standard. This typical approach disregards the needs of the organization in favor of the expectation to perform particular process activities. Often, these typical approaches flout the reality of the organization's operations resulting in an increase in operational overhead costs and a decrease in the long-term viability of the changes to become acculturated and ability for the benefits to remain in place.

This veneer approach is fraught with risk and may add little business value, enjoy no longevity and cost dearly in additional overhead and lost productivity. However, when using the method as disclosed herein, the organization is presented with the opportunity and ability to integrate these various process expectations and in doing so eliminates process redundancies and then removes all of the process layering ‘veneers’ burdening its operations.

An alternative to the typical approach is to regard the operational needs of the business and working, successful practices of the business as assumed effective and value-added, and to incorporate any changes for the benefit of process improvement in a way that is tied directly to value. This alternative approach furthermore incorporates the implementation of a model in the way that engineers and architects implement models—as a means of communicating concepts—rather than as an exact representation of a specific outcome. Unlike the application of standards, the implementation of a model requires that underlying concepts and fundamental principles be understood, and that the model's concepts and principles be evaluated and interpreted in the context of the organization where it is being used before being implemented within the context of specific usages. Only where existing activities do not accomplish business specific model goals, as in the current invention, are new activities added with a clear understanding of the business realities, such that can be added or modified in full context of the individual business and not in a process-centric vacuum.

Among the complaints on process improvement efforts (using CMMI or otherwise) are the resulting overhead process improvement can create for an organization. Similarly, many organizations find that prior to “process improvement” efforts, projects had more flexibility and project teams were more empowered to make project-appropriate decisions leading to successful project completion. Whereas, process “improvements” resulted in processes that were inconsistent with project needs and incompatible with the organization's operating strength. Also among the complaints are the assumptions/expectations that processes can substitute for competent staff or prevent mistakes due to personnel.

These problems are frequently related to one another and stem from a basic cause of processes that are too prescriptive and not created with the “reality” of the organization's operations in mind. To avoid these complaints, processes can be made less prescriptive and project teams be afforded more freedom with the addition of process standards and product standards. Standards provide the minimum criteria by which products and processes are determined to be adequate/suitable to the organization. As long as process performance and products meet these minimum criteria, how they are achieved can be left up to those performing the project activities themselves.

### SUMMARY

The invention of the present method and system allow for the identification of the organization's standards, and allows for process to be less prescriptive and more consistently applied. Standards are generally more readily understood and applied than processes, and, the results of adhering to standards are more easily tested/audited than process outcomes. The Method compiles standards to the organization's new “reality” during the Solutioneering activity.

In view of the foregoing, an embodiment of the invention provides a process improvement implementation method comprising: identifying a business life cycle wherein identifying the business expectation life cycles comprises characterizing at least one business focused document; identifying a product life cycle wherein identifying the product life cycle comprises characterizing at least one project focused document; identifying a process improvement activity, wherein identifying the process improvement activity comprises characterizing at least one process focused document; receiving predetermined organizational standards; synthesizing a organizational specific process improvement; and implementing a process improvement. The identifying of the business expectation life cycles further comprises identifying an activity comprising at least one of: business development; client expectation management; agreement; engagement; vehicles; deliverables; templates; standards; corporate performance level; programmatic; work packages; and work products, and the business life cycle further comprises identifying a project fulfillment life cycle.

The method further provides a process improvement method to: (a) apply a specific organization process improvement model, rather than process improvement standards; (b) engineer a process solution to meet the needs of the organization; (c) operate seamlessly within product and/or service development activities, (d) add long-term value to the organization in general by way of increasing the value of product and/or service development activities; (e) scale with product and/or service development activities and changing organizational needs; and (f) be created, implemented, or modified in a structured manner irrespective of the cause or reason for the activities and irrespective of the model(s) being applied.

It is a purpose of the invention to solve the following problems: (1) the lack of an identifiable method to implement a model for processes and process improvement using a disciplined engineering approach to create process solutions as opposed to imposing external processes, and (2) the lack of products in the market that facilitate an engineering approach to interpret a model in its application towards process implementation and process improvement as opposed to products that: do not facilitate the use of a model, and simply force processes onto organizations for the purposes of creating appraisable artifacts, and/or act as a passive repository for the collection of process artifacts.

“Product and/or Service Development” (product development and/or service development) are the technical activities, tasks, procedures and management involved in the evolution and transformation of concepts and requirements into tangible products and/or experiential services that meet specified needs. Typically, these products and/or services are developed by one party at the request of some other party where there exists a relationship between the parties to meet mutually agreed expectations. Development may equally apply to creating new products and/or services as well as to the modification of existing products and services to meet new needs and achieve new capabilities.

“Work Product” is the output of performing a task including, but not limited to, following a procedure, performing a process, and creating a product or service.

“Process Performance and Improvement Activities” are actions that constitute the execution and/or enhancement of a process for the purpose of causing an expected outcome based on expected inputs and outputs which collectively improve predictability and consistency of the work product(s) to which the process is applied. “Process Performance” is the carrying-out of a process. “Process Improvement” is the actions for the purpose of improving a process or set of processes.

“Standard(s)” is the minimum criteria that work products or process activities must meet irrespective of the physical manifestation of the resulting effort. Some standards may be for specifying the physical manifestation of an effort, but not all standards address these requirements, and thus anyone working in accordance with a standard may be free to exceed the standard and/or to achieve the standard by whichever means they find suits their needs best.

“Process Architecture” is the organization of and relationship among process components that work together to execute processes. This is analogous to the systems architecture of a product whereby each component of the system serves a mostly or entirely unique purpose and is connected to other parts of the system so as to function as the complete system.

“Non native processes” is a process that does not naturally take place in an organization for the benefit of developing their products or services. Many non-native processes are introduced/imposed by some external (i.e., “foreign”) entity with no “stake” in the organization's success such as a regulation, industry standard, etc. Frequently, non-native processes are non-value-added processes that are most often performed for the perfunctory purpose of generating artifacts of the process.

“Expert system” is a system that has “expert” guidance and advice for users to lead them to a close-match between the system's functionality and their needs—thus the user doesn't need to be an expert to use the system, and gets the benefits of an expert's know-how. As opposed to a non-expert system which requires the user to manipulate the system so that it meets their needs, (i.e., the user provides the expertise).

“Project life cycles” are the phases of a project that see the project progress from inception to completion. Typically phases are separated by noticeable events or projects states. A common high-level project life cycle is: (1) Initiation, (2) Planning, (3) Execution, (4) Close-out.

“Product life cycles” is the phases that a product goes through. Typically, these are technical or engineering phases such as: (1) Requirements Gathering, (2) Trade-offs, (3) Architecting, (4) Design, (5) Build, (6) Test, (7) Deploy, (8) Maintain

“Organizations operational standards” is criteria for minimum acceptable activities, work, conduct and products for how the organization conducts business operations.

“Operational reality” is the circumstances of the organization's market, market forces, environment, economics, location, leadership, culture, demographics, history, and other attributes that affect how an organization must operate, as opposed to how an organization wishes it could operate or how an external (“non-native”) activity assumes or expects it to operate. The operational reality also includes their operational standards and all life cycles. The operational reality can also be described as the relationship between what happens inside the company-as-a-system and how it operates in its environment-as-reality.

“Process solution” is a defined, manageable, repeatable, executable “go to” means of performing a process that achieves the balance necessary to meet the array of competing priorities, needs, objectives and requirements faced by an organization; and a set of processes that solve the organization's need to perform processes without sacrificing other operational needs for the sake of the processes. Process solutions synthesize the organization's “operational reality” with the organization's need to implement and make “native” other process expectations.

“Process solutioneering” is the method applying systems engineering principles to process needs to create a process solution. This includes the identification and decomposition of project, product, and process life cycles, the identification of standards and operational realities, and the incorporation of business improvement activities into the re-constitution/re-construction of the organization's activities as a unified process “solution”.

### BRIEF DESCRIPTION OF THE DRAWINGS

The embodiments of the invention can be better understood from the following detailed description with reference to the drawings, in which:

FIG. 1 illustrates a flow diagram of a general overview of the present invention.

FIG. 2 illustrates a flow diagram further describing the method of the present invention.

FIG. 3 illustrates a schematic diagram further disclosing the method of the present invention.

FIG. 4 illustrates details of the sub-processes, activities and tasks of each life cycle identification effort.

FIG. 5 illustrates the Product Life Cycles sub-process.

FIG. 6 illustrates the method used to elicit existing product development life cycles.

FIG. 7 illustrates the sub-process of process identification and decomposition as applied when CMMI is the expected process-oriented effort.

FIG. 8 illustrates where CMMI activities are taking place.

FIG. 9 illustrates the sub-process standards.

FIG. 10 illustrates four common sets of standards for typical organizations.

FIG. 11 illustrates Process Solutioneering Synthesis.

FIG. 12 illustrates Process Solutioneering Synthesis.

FIG. 13 illustrates the entire method of the present business process.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

An embodiment of the invention provides a process improvement implementation method comprising: identifying a business life cycle wherein the identifying the business expectation life cycles comprises characterizing at least one business focused document; identifying a product life cycle wherein the identifying the product life cycle comprises characterizing at least one project focused document; identifying a process improvement activity, wherein the identifying the process improvement activity comprises characterizing at least one process focused document; receiving predetermined organizational standards; synthesizing a organizational specific process improvement; and implementing a process improvement. The identifying of the business expectation life cycles further comprises identifying an activity comprising at least one of: business development; client expectation management; agreement; engagement; vehicles; deliverables; templates; standards; corporate performance level; programmatic; work packages; and work products, and the business life cycle further comprises identifying a project fulfillment life cycle.

In another embodiment, the method further comprises identifying an activity comprising at least one of: project level work streams; management work streams; project templates; standards; reports; performance measures; technical tasks; engineering tasks; and work products. Identifying the project fulfillment life cycle of the present method further comprises: identifying an activity comprising at least one of: on-going task monitors; action mechanism reports; incorporated plan updates; and task-level work products.

It is yet another embodiment wherein the identifying the product life cycle further comprises an activity comprising at least one of: requirement and expectations management; product development; estimation planning; sequencing of development activities; engineering standards; technical standards; tools; practices; work products; technical development; non-technical development; project packages; project packages; and work products. The method may further comprise establishing process area work, goal efforts, practice activities, and procedures.

It is yet another embodiment, that the method further comprises defining existing organizational standards wherein the organizational standards comprise at least one of corporate standards; document standards; process standards and project standards. The method can also further comprise modeling idealized organizational standards. The synthesizing step of the method also may further comprise creating organizational standards by adapting the existing organizational standards to meet the model organizational standards.

It is another embodiment of the invention to provide a system for process improvement implementation comprising: a business cycle compiler adapted to identify a business life cycle, wherein the identifying the business expectation life cycles comprises characterizing at least one business focused document; a product life cycle compiler module adapted to identify a product life cycle, wherein the identifying the product life cycle comprises characterizing at least one project focused document; a process improvement compiler adapted to identifying a process improvement activity, wherein the identifying the process improvement activity comprises characterizing at least one process focused document; a receiver adapted to receiving predetermined organizational standards; a synthesizer adapted to synthesizing a organizational specific process improvement; and a process improvement generator adapted to generating a process improvement standard for a user.

It is yet another embodiment of the invention to provide for a computer program product comprising a computer useable medium having computer program logic recorded thereon for enabling a processor in a computer system to implement organizational process improvement, the computer program logic adapted to executing the method comprising: identifying a business life cycle wherein the identifying the business expectation life cycles comprises characterizing at least one business focused document; identifying a product life cycle wherein the identifying the product life cycle comprises characterizing at least one project focused document; identifying a process improvement activity, wherein the identifying the process improvement activity comprises characterizing at least one process focused document; receiving predetermined organizational standards; synthesizing a organizational specific process improvement; and implementing a process improvement.

The process solution method of the present invention is a business process for use in one embodiment of the invention by process improvement subject-matter experts in the context of organizations performing product and/or service development activities. The purpose of its use is to develop and implement model-based process performance and improvement activities specific to the business and/or organization in such a way which integrates these activities into development activities rather than: (a) forcing existing, productive, successful, streamlined development activities to be modified to incorporate process performance and improvement activities or (b) superimposing process performance and improvement activities onto existing development activities thereby creating additional process overhead not directly inline with or contributing towards the development of the products and/or services.

The outcomes of applying the embodiments of the present method and system are process performance and improvement activities that: (a) apply a specific organization process improvement model, rather than process improvement standards; (b) are engineered as a process solution to meet the needs of the organization; (c) operate seamlessly within product and/or service development activities; (d) add long-term value to the organization in general by way of increasing the value of product and/or service development activities; (e) can scale with product and/or service development activities and changing organizational needs, and (f) can be created, implemented, or modified in a structured manner irrespective of the cause or reason for the activities and irrespective of the model(s) being applied.

In one embodiment, the method and system is a systems engineering approach to implementing process improvement models into existing product and service development activities, and, to incorporating process improvement models into the creation of new development operations. It is an embodiment of the present invention to achieve process improvement goals by implementing process improvement practices. The present method and system provides the notion and focus of decomposing organizational activities into three distinct and concurrent operational areas, developing requirements from these operational areas, developing standards for the organizations work products, and synthesizing the requirements into a process solution architected to meet the operational needs of the organization and organized to be acculturated throughout the organization.

It is an embodiment of the present method to provide a consistent business process to apply engineering principles to the formation of a process architecture and a process solution. A solution that integrates the organization's existing practices with value-added processes and process improvement activities: reducing risks, delivering immediate benefit, assuring long-term viability and maintaining complete fidelity to what already works well for the organization.

There are a number of process improvement methods for improving development activities and tools that focus on implementing process improvement activities but fail to address or provide guidance for the incorporation of these process improvement activities into existing development work. The Software Engineering Institute (SEI) promotes a comprehensive process improvement model called, IDEAL®, but it too does not include the decomposition of the organization's needs and the CMMI, nor does it include the re-composition of a process solution using systematic systems engineering synthesis.

Several products/tools on the market, in effect, merely provide a copy of CMMI and a space in which to indicate how the model's practices are being accomplished. If the organization doesn't perform the practice some tools provide sample practices and/or a place where the organization can describe its practices and in either case to indicate where one might find the evidence of such practice performance. Again, in no way do these tools suggest or guide how to decompose the organization's needs, interpret CMMI based on its principles, concepts and objectives, and then how to engineer process solutions to meet their needs.

At a high-level (with details in the accompanying Visio diagrams), the unique features of an embodiment of the present method are:

Identifying and establishing the target organizational reality prior to implementing any changes to the organizational reality. The organizational reality constitutes how they currently operate including what does and does not work. This reality forms the basis of the organization's requirements for accomplishing process performance and improvement and includes their reality for project activities, product development activities and process activities.

Segregation of “Project life cycles” from “Product life cycles” and these from the Process activities as three separate attributes of the organization's operations. Decomposition of specific business operations of the organization (i.e., defining their context). Decomposition of CMMI for Development in the context of the organization (i.e., interpreting CMMI). Identification of work product standards that are specific to the organization in question. Application of systems engineering synthesis to combine the organization's business operations requirements with the principals, concepts and objectives of CMMI. Reconstitution of a process architecture and process solution uniquely tailored to the context of the organization.

Another embodiment of the present invention comprises a computer program product adapted to perform the method disclosed herein. The product can provide a framework in which the methods disclosed herein in a particular organization's practices can be brought together to carry out the method in an automated fashion (e.g. organizational reality). The product can include expert system guidance to perform the decomposition and reconstitution activities of the method without imposing any “non-native processes”. The product would include comprehensive and continually evolving content to help with CMMI interpretation and artifact examples and can allow users to add their own content as well as to simplify the identification of their “practice implementation artifacts” should they be interested in conducting model-based appraisals of their goal achievement. The product allows for the aggregation of practices where the organization may be attempting to demonstrate their practice performance against several process models, procedure requirements and standards at once.

### Detailed Description of the Invention

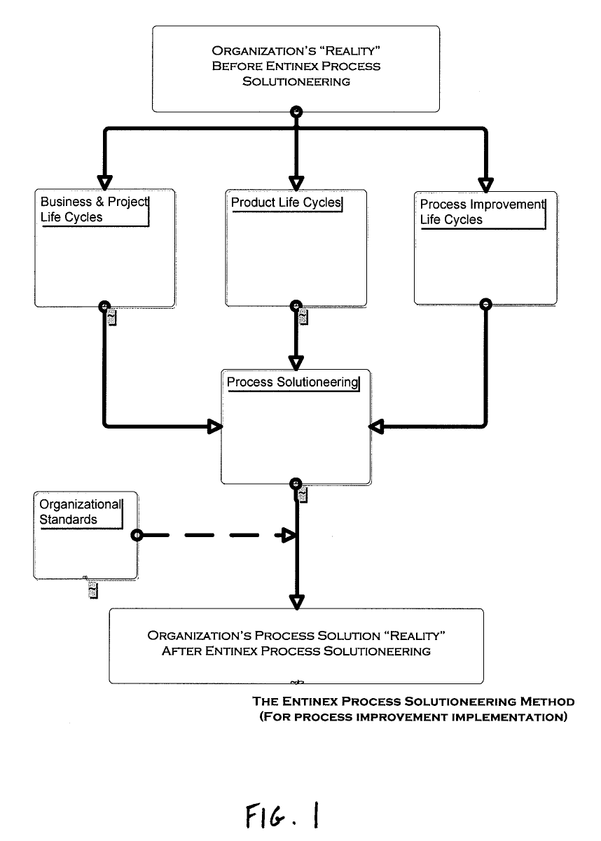

Referring now to the drawings, and more particularly to FIGS. 1 through 13, where reference characters denote corresponding features consistently throughout the figures, there is shown a preferred embodiment of the invention.

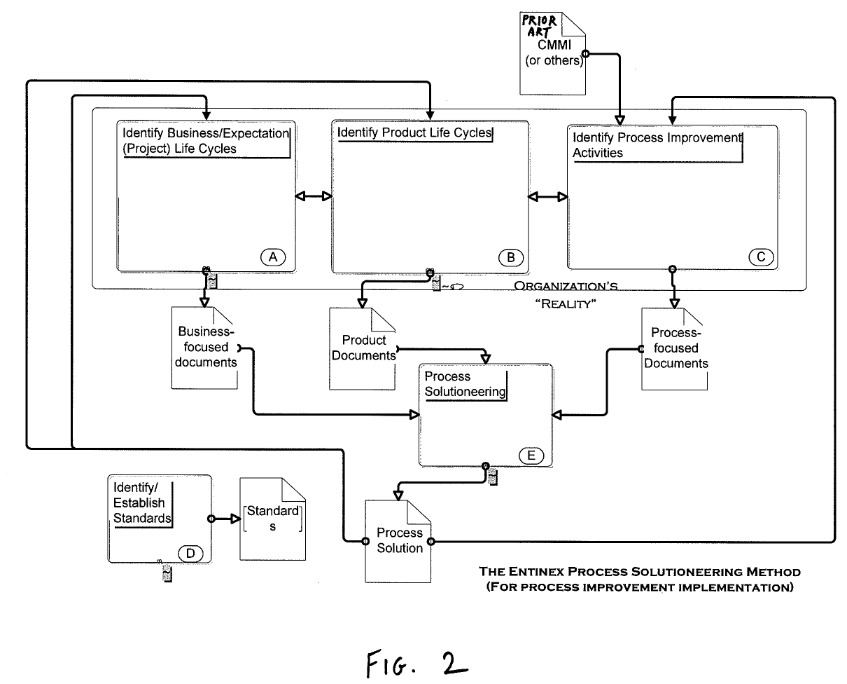

The process solutioneering method disclosed herein is depicted in an accompanying set of diagrams. FIG. 1 discloses a general overview of the invention. FIGS. 2-13 further describe in detail each step involved in the steps disclosed in FIG. 1. Only the salient and unique components of the Method are depicted. Common activities such as scheduling, planning, organizing, coordinating, note-taking, reporting, etc. take place, but are not depicted in the sub-processes. Hence, although some images use conventional business process modeling notation and indicate the presence of other sub-processes, activities and tasks, not all such additional efforts can appear in the diagrams.

FIG. 1 depicts the flow of the overall process solutioneering method business process. The three major elements of the business process include: 1) decomposing of the organizational reality into distinct life cycles and elicitation of process improvement goals; 2) recognizing, codification and application of inherent Organizational Standards; and 3) reconstituting (i.e. Process SOLUTIONEERING™) of the organizational life cycles consistent with process improvement goals.

The organizational reality before the business process is applied is unlikely to distinguish between project, product, and process improvement life cycles. It is an embodiment of the invention to distinguish between project, produce and process improvement life cycles, decompose them into identifiable components, orthogonally or organically (as appropriate), relate them to one another, and create organization specific requirements for an organizational reality to be used later in the process, details are herein. The invention further comprises recognizing the organization's operational standards; whether inherent, implied, de-facto or deficient and in need of establishing, these standards for work performed and work products are a beneficial by-product of the life cycle decomposition element. The last element is the application of systems engineering to recompose/reconstitute the life cycles such that they account for all the requirements and standards.

The primary benefit to the present method is the implementation of a process improvement model fully integrated with the organizational reality. The focus on the organizational reality accounts for the operational components required for a new operational reality to be constructed. The alternative to this method is that a one-size-fits-all standard is laid atop the existing organizational reality, causing severe productivity losses and increased wasted effort—instead of improvements being integrated into the operations. Similarly, other model implementations result in existing operations being contorted to match the model rather than building a new process reality that fits the specific organizational reality which will always be unique and not subject to cookie-cutter solutions. The outcome of the present invention is a Process Solution meeting the needs and expectations of the business, operating seamlessly with the organization's product development methods, and achieving the goals of process improvement.

FIG. 2 further depicts the entire Method at a high level where each of the major sub-processes are represented by large blue boxes. The sizes of the boxes are arbitrary and not related to the size or complexity of the sub-processes or tasks within them. The flow of information between sub-processes is also on this diagram as are the major output “documents” of the activities of each box. Some sub-process document outputs are inputs to other sub-processes while others are outputs or outcomes that are input to the Method or the results of the Method.

On the high-level depiction of FIG. 1, we see the sub-processes that represent the identification/establishment of the organizational reality. And, how the output of the invention's main engine, Process Solutioneering feeds back into the reality.

Each major sub-process is labeled “A” through “E” in FIGS. 2-13 to consistently provide reference to the subsequent tabs which detail each sub-process box. The CMMI (prior art) is only an input to the organization's process improvement activities.

This diagram shows the high-level set of documents/outputs from each of the sub-processes.

Details of each output are described on subsequent tabs.

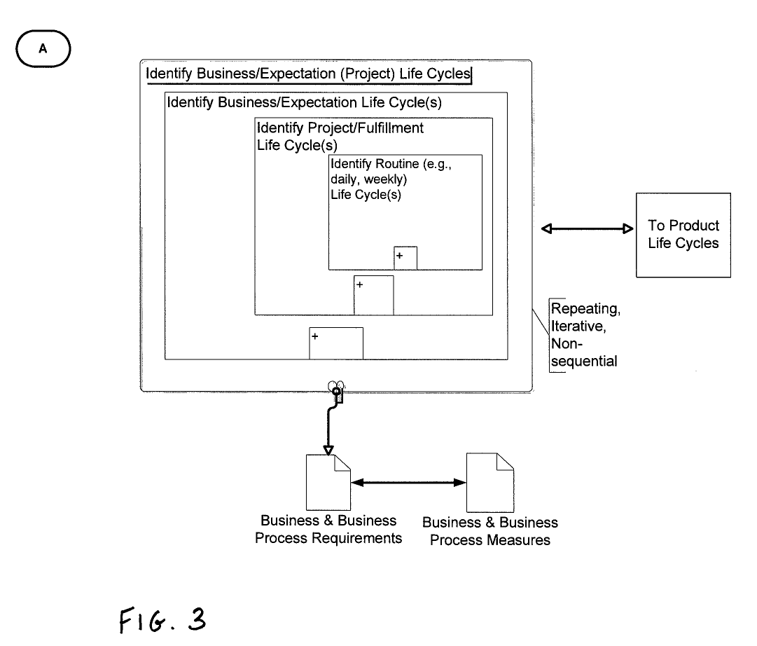

Item A as depicted on FIG. 3 is the Project level sub-process and depicts the “Identify Project Life Cycles” sub-process. Within this sub-process are three distinct but concurrent life-cycles—Business/Expectation, Project/Fulfillment, and Routine—which must be identified or established as part of the Method.

These life cycles are related in that the smallest box inherits attributes from the middle box which inherits attributes from the largest box. In this way, these life cycles have a cascading effect from the largest to the smallest box and are thus referred-to as “CASCADING LIFE CYCLES™”

NOTE: This sub-process, as others in the present invention, can be iterative, repeating, and non-sequential. They do not always follow an explicit order, they make progress through recursive growth where new information is added to existing information which drives the next new information sought and added, and they repeat the tasks as needed until reaching a particular state of completeness sufficient for moving on to the next activity or task which likely operates in the same manner.

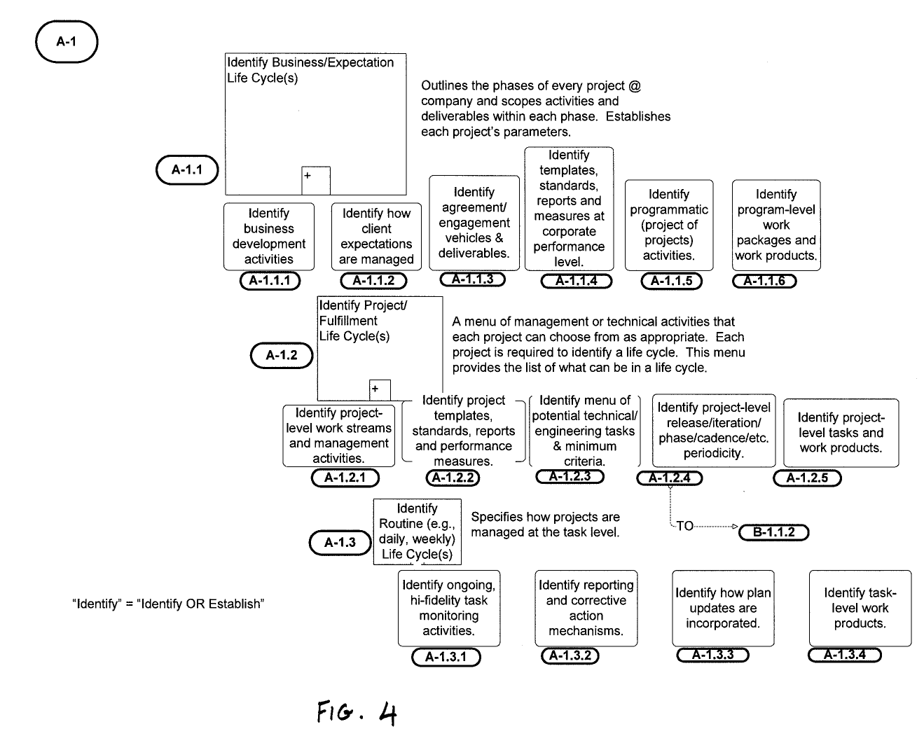

The Business/Expectation life cycle in FIG. 3 represents the organization's business development life cycle to include how the organization manages its relationships with clients and the external world. This life cycle accounts for contractual and fiscal obligations as well as managing expectations and all that is involved with representing the organization to its clients and others external to the organization performing product and service development. With each new project, the Business/Expectation life cycle can establish the parameters of operation and rules for the project based on whatever commitment(s) the organization has made to its customer(s). Organizations must understand their actual Business/Expectation life cycle before they appreciate how they manage projects. Project-oriented life cycles are clearly linked to product development life cycles as indicated by the communication arrow between this sub-process and the “Product Life Cycles” sub-process (Item B in FIG. 4).

The outcomes of the Project life cycle sub-process, FIG. 4, are an understanding of the organization's approach to executing projects at various levels of the organization. The identification of roles, responsibilities, accountability, and authorities results from the introspection of the organization into the reality of their project activities.

The outputs of these efforts are captured in “documentation” describing the processes, expectations and performance of project life cycles for the organization. Business requirements and business process requirements are derived from these descriptions and from these requirements, measures important to the business and its processes are derived.

The Project/Fulfillment life cycle of FIG. 3 organizes the project into its delivery iterations or phases of activity. Project planning and management activities are performed to ensure coordination and delivery of the appropriate work products to the appropriate people at the expected times. This life cycle includes allocation and provision of resources and assignment of responsibilities as well as all control mechanisms to oversee the project efforts. The Project life cycle determines how the day-to-day work of the project, including task management and routine reporting can take place. This determination is made based on the needs of the project which reflect the urgency, timelines and complexity of the project. Organization must understand how they actually run projects before they can fully appreciate their decisions about how to operate on a daily, weekly, monthly or other routine basis.

The Routine life cycle establishes the rhythm of the project including internal meeting content and frequency, task distribution, development progress reporting and issue escalation and resolution. Internal team interactions, norms, and behavior patterns are matched to the needs of the project and balanced with the needs of the development team. These routines are commonly a daily effort, but often take place in weekly increments or in some cases monthly. In certain environments they can take place even multiple times per day. Throughout the project life cycle identification effort, organizational standards are captured, collected, aggregated and organized in support of the activities in Tab D.

Item A-1 of FIG. 4 discloses details of the sub-processes, activities and tasks of each life cycle identification effort are depicted in this image. Wherever the organization does not have existing project life cycle activities (formally or informally), they are established by targeted interviews with appropriate personnel and review of the organization's own materials and tools.

At a minimum, the information identified in the series smallest task boxes under each sub-process (A-1.x.y) are obtained and analyzed for incorporation into the outcomes and outputs of this sub-process. The outcomes of this sub-process comprise exposing and defining the business, project, and routine life cycles of the organization.

Throughout the project life cycle identification effort, organizational standards are captured, collected, aggregated and organized in support of the activities in Tab D.

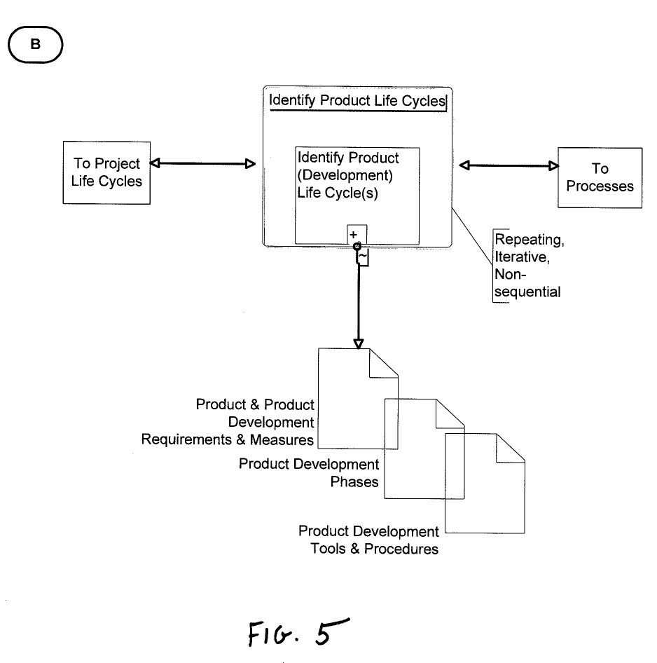

Item B of FIG. 5 describes the Identify Product Life Cycles sub-process where the organization's technical, engineering, and management activities—specific to product and/or service creation—are revealed and re-formulated to provide input to the “Process Solutioneering” of the organization's process performance and improvement process needs. These development activities can vary widely from project to project and therefore comprise a wide array of technical and managerial actions, tasks, and work streams that can be employed to create a particular product or service.

Product-oriented requirements and measures as well as requirements and measures for product development are created by this sub-process. The common framework for phasing of product development can also be identified as the very particular tools and procedures used by the organization to develop products and services.

In FIG. 5, Product Life Cycles are depicted as being a “go-between” Project (Business/Expectations) Life Cycles and Process Improvement Activities. While Process Improvement activities can connect directly to Business/Expectation management activities, this depiction with Product Life Cycles being between the two is not meant to limit or prohibit a direct Process Improvement activity connection to or communication with Business/Expectation life cycles.

Product Life Cycles commonly include many possible combinations and permutations of technical, engineering, and managerial activities. Product life cycles and project life cycles overlap often, however, the distinction between product and project life cycles are that the project's life cycle events are typically contractual or schedule-driven, whereas the product life cycles are driven by the continual evolution of the product from concept to fruition. Often, product life cycles are worked through many times for any one product component or module, and several life cycles of combinations of product components or modules take place in the same span of time as a single project life cycle instance.

To account for the variability in Product life cycles, the result of this sub-process generates a menu of all possible product-oriented activities from which each project selects those activities to be performed by the project in its product development follow-through. These options include basic product development phasing, iteration planning, and a means to prioritize development tasks and functionality implemented into the product or service.

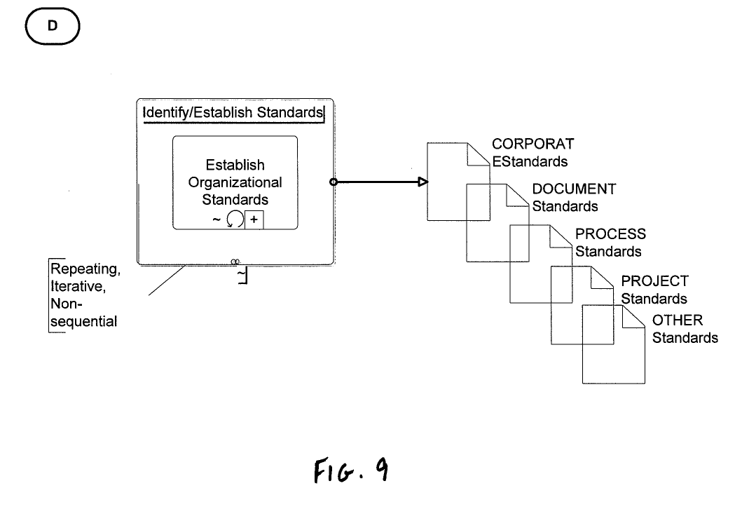

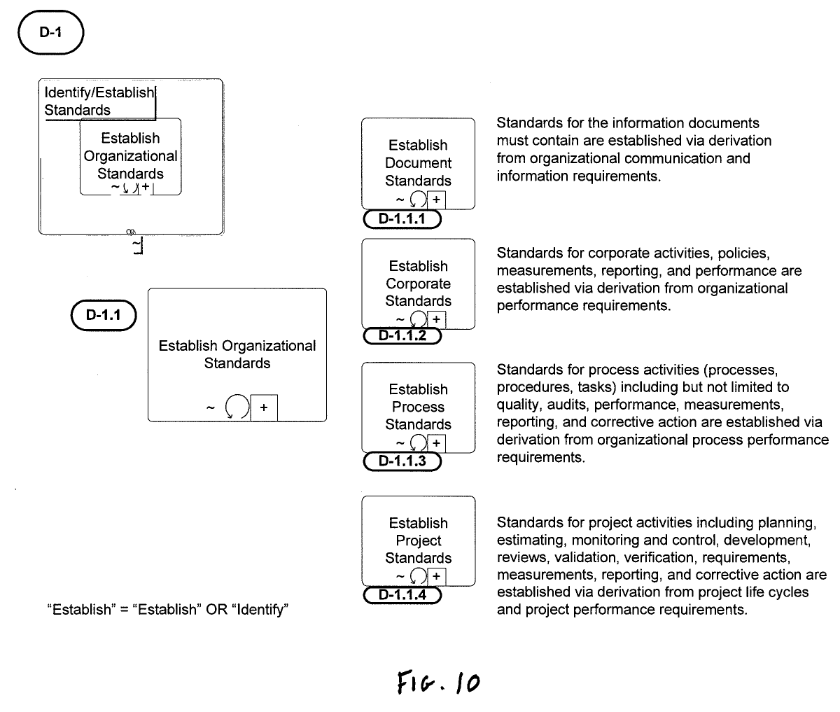

In this manner, organizations and projects are free to create product-development life cycles that suit project needs without locking any one project into an ill-fitting development approach. Ultimately, what organizations desire, and what the present invention provides can be enhanced product development methods that perform processes and process improvement activities without increasing the duration, complexity, or waste in the development life cycle. Project life cycles tend to fall into business overhead. While they may be charged to product activities in applying value-stream mapping, project activities seldom contribute to the product and are therefore inherently non-value-added to the product even though they may be adding value to the organization. With this in mind, it is yet another embodiment of the invention to delve into tools and procedures that are highly context-specific to the organization implementing the process improvements. Throughout the product life cycle identification effort, organizational standards are captured, collected, aggregated and organized in support of the activities in Item D of FIGS. 9 and 10.

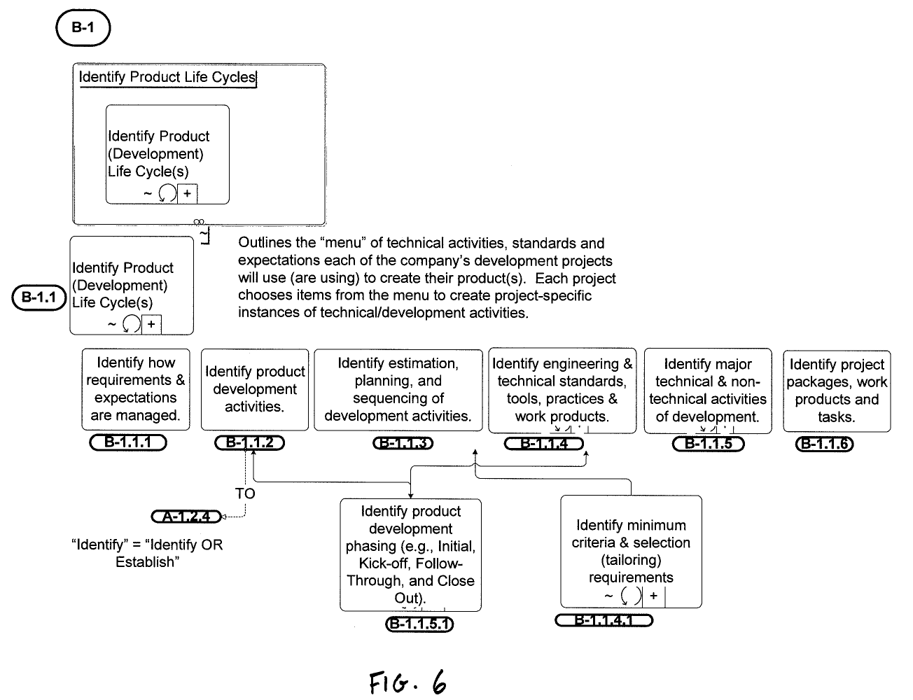

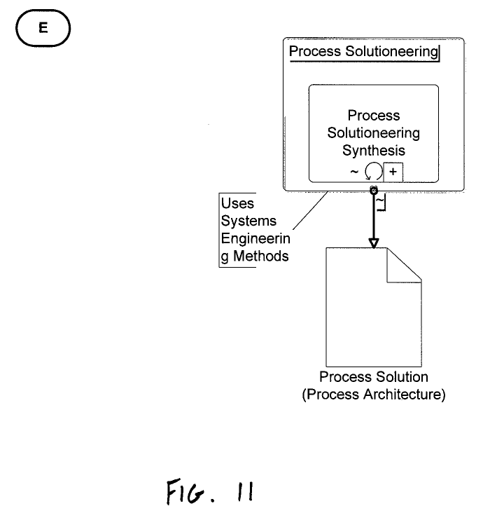

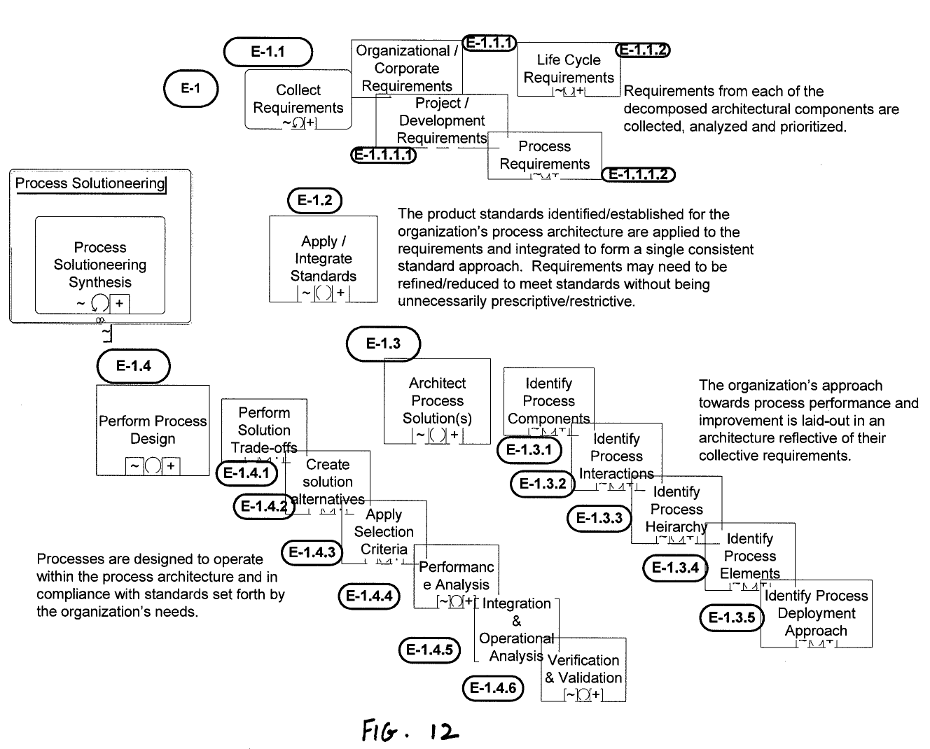

Item B-1 of FIG. 6 illustrates the sub-process tasks in this depiction convey the method used to elicit existing product development life cycles and identify the need for formalizing new product development life cycles distinct from the project life cycles (Item A, FIGS. 3 and 4) and process activities (Item E, FIGS. 11 and 12).

At a minimum, these tasks and sub-processes elicit the organization's means of developing the products they produce beginning with the source of the product's inception, development and management of the product's requirements, understanding of the architecture, design, feature management, quality controls, testing, and all other technical considerations such as interfaces, integration, verification, validation, and control of products. The “menu” of product development life cycle activities, work products, and tools are created by the effort in this sub-process. Identification of these attributes help derive the organization's requirements for developing products and measures for managing the development.

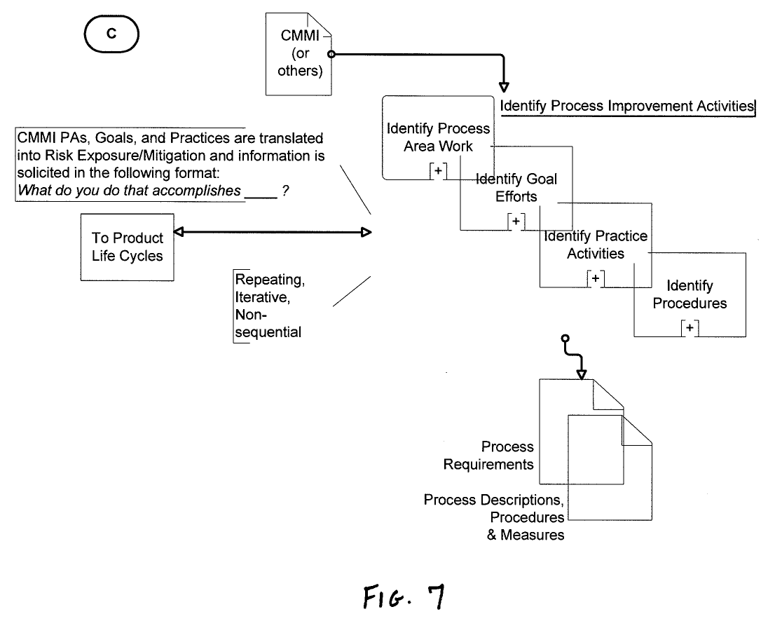

Item C of FIG. 7 describes the sub-process of process identification and decomposition as applied when CMMI is the expected process-oriented effort. The sub-process would work equally well with no substantive changes were the CMMI exchanged with some other body. Processes are directly connected to product development life cycles since the processes are mostly performed during the creation of a product.

The structure of CMMI is hierarchically organized into “Process Areas” composed of “Goals” which are composed of “Practices”. It is an embodiment of the present invention to accommodate ongoing business concerns having an existing and demonstrated set of processes that collectively may perform CMMI process areas by satisfying the CMMI goals.

It is yet another embodiment of the present invention to accommodate the case of organizations lacking any implementation of CMMI or other process areas. The present invention can create procedures and processes to accomplish these goals.

The outputs of Identifying Process Improvement Activities include the set of requirements for performing processes and the set of descriptions and measures attributed to each performed process and its practices and procedures.

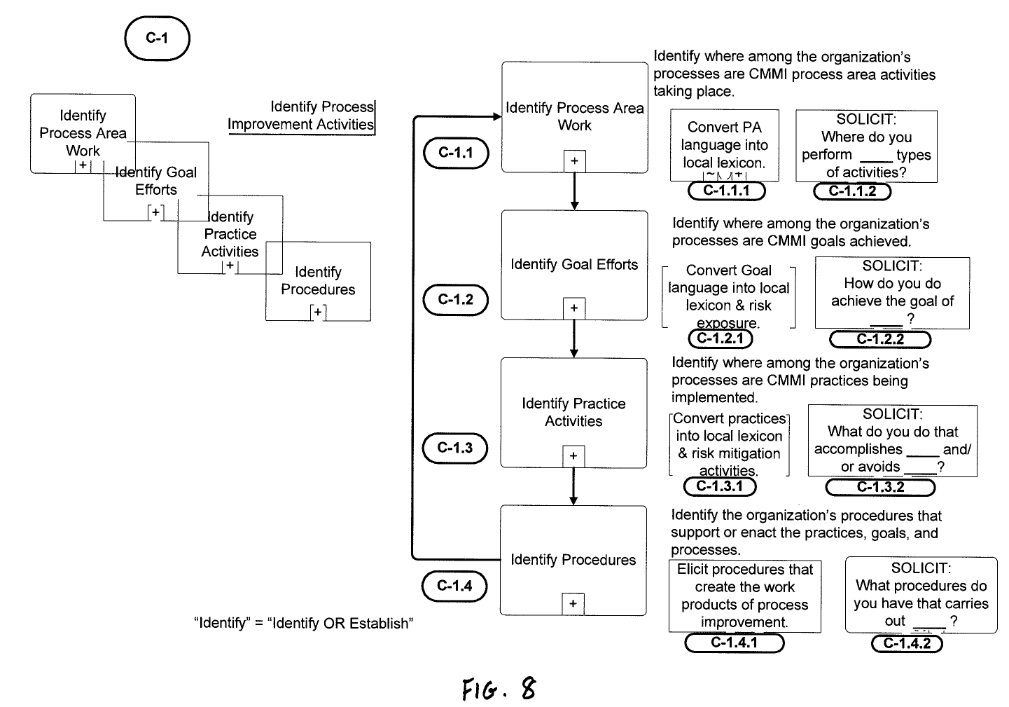

Item C in FIGS. 7 and 8 disclose facilitating the identification of process activities through guided interviews or expert content as in the case of the envisioned product. The process activities are solicited by asking, “What accomplishes X?” Where X is a translation of process methodology text into ordinary terms contextually relevant to the organization. Frequently, X is best comprehended by the organization's personnel if presented in terms of risk avoidance or avoidance of outcome, Y. The question is thus “How does the organization avoid the risk of Y happening?” Accordingly, if X is a practice in the model and performing X avoids Y, many organizations better understand how to avoid Y than recognize that the organization is performing X. The method, therefore, calls for inquiring on avoiding Y, but then confirming that avoiding Y indeed is performing X.

Item C-1 in FIG. 8 describes the sub-sub-processes and tasks of this sub-process are iterative, cumulative, and recursive. The organization's scope of development-oriented process activities are examined wherever and whenever they may be found throughout the performance of product-oriented or service-oriented projects. Where process activities are discovered to be lacking or short-falling the needs of the organization, these needs are documented such that they can be addressed via the Solutioneering step. The identification of existing and needed process requirements and definitions results from these activities.

Item D in FIG. 7 describes the sub-process for identifying organizational standards. As the life cycles are decomposed and inner workings and relationships are discovered and connected, the organization's standards and need for standardization can emerge. It is a by-product of the life cycle decomposition that enables processes and work products to be released from prescriptive requirements and empowers staff to perform their tasks in the most effective/efficient way, as long as their efforts meet the standards when completed. The standards for the business, it's projects, it's product development, and process performance (and any others as determined by the organization's context) are generated by this activity.

Item D in FIGS. 9 and 10 describes the sub-process identifying existing standards (whether or not they are internally or externally imposed and/or formally recognized). The Figure also describes the step of creating standards where standards are needed but do not exist. When the “Synthesis” activity is performed, the standards are used to ensure resulting operations meet the minimum criteria set forth in the standards.

Item D-1 in FIG. 10 describes the generation of four common sets of standards for typical organizations. For each type of criteria, a set of standards is created.

Item E in FIGS. 11 and 12 describe the syntheses process comprising Process Solutioneering Synthesis which is an iterative and incremental integration of many requirements and standards concurrently. This process evolves all life cycles, project, product and process, towards a unified process solution. At its core, Process Solutioneering Synthesis is a systems engineering approach to balancing multiple concurrent requirements further optimizing the overall system of processes rather than over-optimizing any one part of the system at the expense of others. The synthesis of product and project life cycles, organizational standards, and process improvement goals is the essence of applying a process improvement model developed specifically for a particular organization (as opposed to imposing an external process standard). The major sub-sub-processes include requirements collection, application and integration of standards, and the architecting and design of the process solution. Within each sub-sub-process are the details of various engineering components that contribute to the overall process system.

Although a single large sub-process is depicted on FIG. 11, the actual activities are numerous and involved. FIG. 12 describes lower-level activities. The outcome of this sub-process is the “Process Solution” for the organization. A solution that is engineered, not imposed. And, a solution that resulted from the requirements of the organization, not the dictates of an outside entity.

Item E-1 on FIG. 12 comprises processes central to engineering analysis, which is central to systems engineering. The present method employs engineering analysis and systems engineering synthesis to the application of a process model into an existing operational context.

At a minimum, unless local contexts require otherwise, the component activities and respective outcomes of Process Solutioneering Synthesis are depicted on this tab. The analysis and synthesis are performed in consideration of the standards identified and created as discussed herein. Engineering analyses, system architecture and design elements, and the overall process solution result from the activities on this Figure.

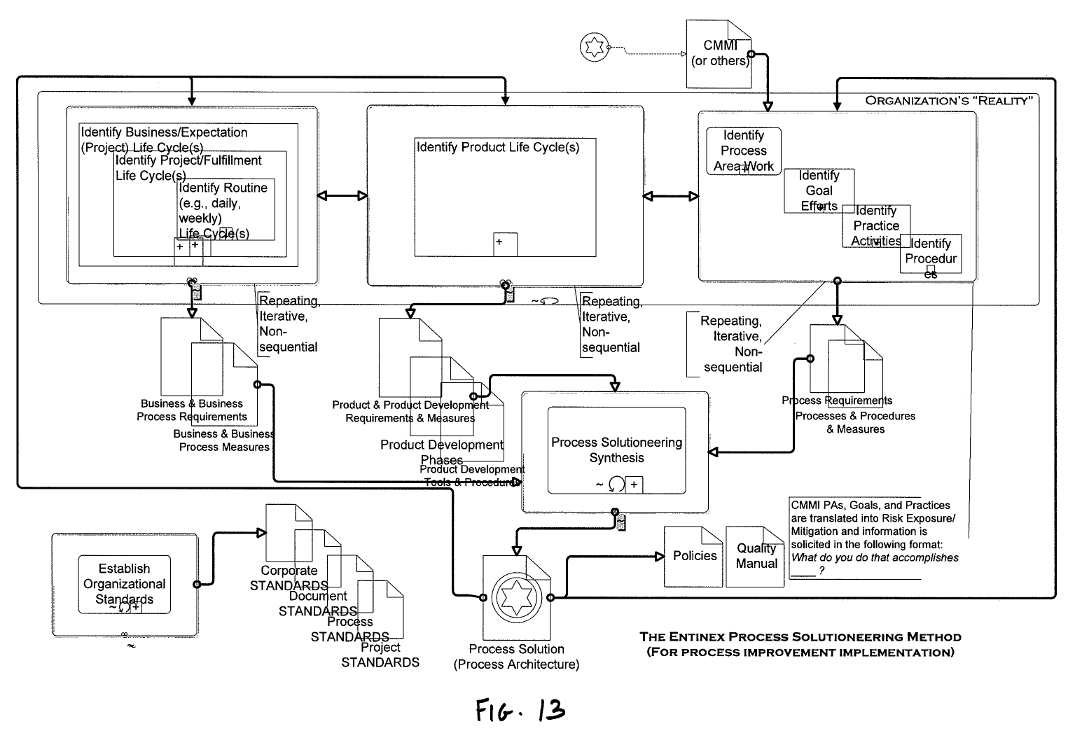

FIG. 13 describes the overall picture of the entire method of the present business process including major sub-processes and outputs collectively.

It is yet another purpose of the inventions to synthesize all of the requirements contributing to an organization's operation. Included are the process needs of the organization and the standards needs of the organization. By collecting the process needs with the standards needs, one of many side-benefits of the process is the formulation of a standard for performing processes throughout the organization. In other words, the overall means by which the organization is acculturated with a process-oriented disposition becomes an intentional by-product of the present invention.

Organizations following various embodiments of the present invention, as described herein, have the ability and opportunity to include these efforts in their synthesis of process activities. Since externally imposed, and sometimes internally imposed, process activities often appear after the organization has already established its operational methods, a common practice among organizations when receiving new process expectations is to add a process veneer to their existing operations so as to impact their underway activities as little as possible while still demonstrating adherence to whatever process expectation is required of them. Each new expectation adds a new layer of process veneer, often requiring duplication of process effort to address each different demand.

The foregoing description of the specific embodiments can so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art can recognize that the embodiments of the invention can be practiced with modification within the spirit and scope of the appended claims.

1. A method for process improvement implementation comprising the steps of:
identifying a business expectation life cycle, wherein the step of identifying said business expectation life cycles comprises characterizing at least one business-focused document;
identifying a product life cycle wherein said identifying the step of product life cycle comprises characterizing at least one project-focused document;
identifying a process improvement activity, wherein the step of identifying said process improvement activity comprises characterizing at least one process-focused document;
receiving at least one pre-selected organizational standard;
synthesizing at least one organizational-specific process improvement; and
implementing said organizational process improvement.

2. The method of claim 1, wherein the step of identifying of said business expectation life cycle further comprises identifying an activity comprising at least one of: business development; client expectation management; agreement; engagement; selecting vehicles; establishing deliverables; templates; standards; corporate performance level; programmatic; work packages; and work products.

3. The method of claim 1, wherein the step of identifying a business expectation life cycle further comprises selecting a project fulfillment life cycle.

4. The method of claim 3, wherein said step of identifying a project fulfillment life cycle further comprises selecting a project activity comprising at least one of: project level work streams; management work streams; project templates; standards; reports; performance measures; technical tasks; engineering tasks; and work products.

5. The method of claim 3, wherein said step of identifying said project fulfillment life cycle further comprises identifying an activity comprising at least one of: on-going task monitors; action mechanism reports; incorporated plan updates; and task-level work products.

6. The method of claim 1, wherein the step of identifying an expected product life cycle further comprises an activity comprising at least one of: requirement and expectations; product development; estimation planning; sequencing of development activities; engineering standards; technical standards; tools; practices; work products; technical development; non-technical development; project packages; project packages; and work products.

7. The method of claim 1, further comprising the step of establishing at least one of process area work, goal efforts, practice activities, and procedures.

8. The method of claim 1, further comprising the step of defining existing organizational standards wherein said organizational standards comprise at least one of corporate standards; document standards; process standards and project standards.

9. The method of claim 1, wherein said step of synthesizing at least one organizational-specific process improvements further comprises creating model organizational standards by adapting said pre-selected organizational standards to meet the model organizational standards.

10. A computer readable medium having computer-executable instructions thereon for performing method for process improvement implementation, the method comprising the steps of:
applying a specific organization process improvement model, the model not comprising process improvement standards;
engineering a process solution, wherein pre-selected needs of an organization are met,
implementing product and/or service development activities, wherein said operating is a seamless activity;
adding long-term value to the organization comprising increasing at least one of the values of product and service development activities;
scaling said specific organization process improvement model, the step of scaling comprising selecting at least one of product or service development activities, and changing organizational requirements, and
creating, implementing, or modifying said specific organization process improvement model in a structured manner the step of creating is performed irrespective of the cause of an activity and irrespective of identified standards applied.

11. A computer readable medium having computer-executable instructions for implementing an organizational process improvement method, said method comprising the steps of:
identifying a business expectation life cycle, wherein said identifying said business expectation life cycles comprises characterizing at least one business-focused document;
identifying a product life cycle, wherein said step of identifying a product life cycle comprises characterizing at least one project focused document;
identifying a process improvement activity, wherein said step of identifying a process improvement activity comprises characterizing at least one process focused document;
receiving predetermined organizational standards;
synthesizing an organizational-specific process improvement; and
implementing the organizational-specific process improvement.

12. A system for process improvement implementation comprising:
a business cycle compiler adapted to identify a business life cycle, wherein said identifying said business expectation life cycles comprises characterizing at least one business focused document;
a product life cycle generator module adapted to identify a product life cycle, wherein said step of identifying a product life cycle comprises characterizing at least one project focused document;
a process improvement adapter adapted to identifying a process improvement activity, wherein said step of identifying a process improvement activity comprises characterizing at least one process-focused document;
a receiver adapted to receiving pre-selected organizational standards;
a synthesizer adapted to synthesize an organizational-specific process improvement; and
a process improvement generator adapted to generate a process improvement standard for display to a user.

13. The system of claim 12, wherein said step of identifying of a business life cycle further comprises identifying a project fulfillment life cycle.

14. The system of claim 13, wherein said step of identifying a project fulfillment life cycle further comprises identifying an activity comprising at least one of: project level work streams; management work streams; project templates; standards; reports; performance measures; technical tasks; engineering tasks; and work products,

15. The system of claim 13, wherein said step of identifying a project fulfillment life cycle further comprise: identifying a project activity comprising at least one of: on-going task monitors; action mechanism reports; incorporated plan updates; and task-level work products.

16. The system of claim 12, wherein said step of identifying a product life cycle further comprises an activity comprising at least one of: requirement and expectations management; product development; estimation planning; sequencing of development activities; setting engineering standards; setting technical standards; setting tools; practices; setting work products; setting technical development; setting non-technical development; setting project packages; setting project packages; and setting work products.

17. The system of claim 12, further comprising the step of establishing at least one of; process area work, goal efforts, practice activities, and procedures.

18. The system of claim 12, further comprising the step of defining existing organizational standards, wherein said organizational standards comprise at least one of: corporate standards; document standards; process standards; and project standards.

19. The system of claim 12, wherein said synthesizing further comprises creating organizational standards by adapting said existing organizational standards to meet the model organizational standards.

20. A computer readable medium having computer-executable instructions thereon for executing the method comprising the steps of:
applying a specific organization process improvement model, the model not comprising process improvement standards;
engineering a process solution, wherein the specific needs of the organization are accomplished,
operating within product and/or service development activities, wherein said step of operating is a seamless activity;
adding long-term value to the organization, the step of adding comprising at least on of increasing the value of product, and service development activities;
scaling said specific organization process improvement, the step of scaling comprising at least one of considering product or service development activities and changing organizational requirements, and
creating, implementing, or modifying said specific organization process improvement in a structured manner irrespective of the cause of an activity and irrespective of identified standards applied.

21. A system for process improvement implementation comprising:
a specific process improvement modeler adapted to apply a specific organization process improvement model, the model not comprising process improvement standards;
a generator adapted to engineer a process solution, wherein the specific needs of the organization are accomplished,
an operator adapted to operate within product or service development activities, seamlessly;
a modulator adapted to scale said specific organization process improvement the scaling comprising considering product or service development activities and changing organizational requirements; and
a synthesizer adapted to create, implement, or modify said specific organization process improvement in a structured manner irrespective of the cause of an activity and irrespective of identified standards applied.
wherein long-term value is added to said organization and increases the value of product or service development activities.
